(19) United States
(12) Patent Application Publication
(10) Pub. No.: US 2008/0159222 A1
(43) Pub. Date: Jul. 3, 2008

(54) Duplicate Address Detection Optimisation

(76) Inventors: Ammad Akram, Reading (GB); Nikolaos Prelorentzos, Athens (GR)

Correspondence Address: RATNERPRESTIA, P.O. BOX 980, VALLEY FORGE, PA, 19482, US

(21) Appl. No.: 11/587,167

(22) PCT Filed: Apr. 1, 2005
(86) PCT No.: PCT/GB05/01282

§ 371 Date: Aug. 29, 2007

(30) Foreign Application Priority Data
Apr. 23, 2004 (GB) 0409138.5

(51) Int. Cl. H04Q 7/00

(52) U.S. Cl. 370/331

(57) ABSTRACT

Duplicate Address Detection Optimisation is achieved by allocating a temporary address to a mobile node by an access muter that it uses to receive time critical data whilst the conventional DAD process completes on An address generated by the mobile node itself.

This invention relates to mobile communications and in particular it relates to methods for making Duplicate Address Detection (DAD) compatible with both Cryptographically Generated Addresses (CGA) and the Fast Mobile Internet Protocol (FMIP).

### INTRODUCTION

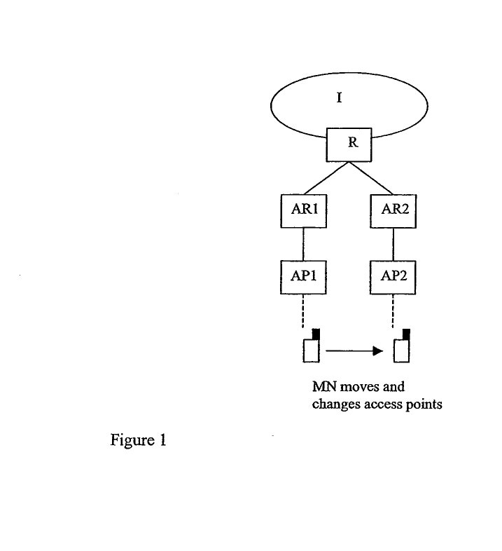

FIG. 1 shows a standard Mobile IPv4 [1], Mobile IPv6 [2], FMIP [3] configuration for enabling mobile communications between a Mobile Node (MN), such as a portable telephone, and a Corresponding Node (CN), not shown, via the Internet I. The Mobile Node MN is wirelessly connected to the network via the access point AP1 initially and subsequently via AP2 and the access routers AR1 and AR2 are connected to the Internet via a Router R.

Upon connection to AP2, the MIPv4/v6 protocols require the MN to obtain a new Care Of Address (nCoA) that is subsequently registered with the Home Agent (HA) and for MIPv6, additionally, also the CN. Upon completion of these so-called binding update (BU) operations, the MN is able to receive data packets via AR2. For real-time applications in particular, the BU latency for MIPv4/v6 may prove too great to maintain a desired quality of service. In such instances, FMIP with its modes of predictive and reactive operation (explained in detail below) can be used to obtain lower BU latency. The FMIP protocol broadly allows the MN to send packets as soon as it detects AR2 and for packets to be delivered to the MN as soon as AR2 detects the presence of the MN.

Regardless of whether MIP or FMIP is being used to complete the handover between AR1 and AR2, handover, an IPv6 CoA can be obtained through stateful

The present invention focuses on stateless address configuration case where the uniqueness of the generated CoA needs to be verified using the Duplicate Address Detection (DAD) protocol. IPv6 prohibits the assignment of a new IP address to a physical MN interface, whether for MIP or any other purpose, before that address has been proven to be unique on the link using DAD.

Stateless address configuration enables a host to generate its own address using a combination of locally available information and information advertised by access routers. Access routers advertise prefixes that identify the subnet(s) associated with a link, while nodes generate a link local address that uniquely identifies an interface on a subnet. A globally routable address is formed by combining the link local address and subnet prefix after the link local address has been proven to be unique, i.e., not already in use by another node on the link.

The conventional DAD protocol [4] requires the MN to inform its neighbours of the tentative link local address it intends to take up and wait for replies from any node already using that address. There is a random initial delay between 0-1 seconds before the MN can inform its neighbours and then there is an additional delay of around 1 second that the MN waits for replies from neighbours. Such delays in communicating with neighbours interrupt any ongoing sessions that the MN wishes to transfer between AP1 and AP2. The resulting data loss makes conventional DAD particularly unsuitable for real-time applications.

Optimistic DAD [5] is one proposed method to overcome some of the limitations of conventional DAD. Here, the MN assumes that the probability of another MN using its tentative link local address is very low and registers this address with the network before DAD has completed, enabling it to receive data earlier from AP2 than it would with completion of conventional DAD.

Optimistic DAD carries the penalty of modifying the conventional DAD protocol and is only applicable for low collision probability networks. Modification of the conventional DAD protocol creates compatibility problems for a network attempting to simultaneously support both optimistic and conventional DAD nodes. In the case of address collision, data intended for the MN via AP2 is directed to the node already validly using the MN tentatively proposed address, causing problems for both nodes concerned. Another important disadvantage of the optimistic method is its incompatibility with the FMIP protocol.

Advance DAD [6] is another proposed method to optimise the conventional DAD protocol that seeks to completely remove DAD latency. An access router (AR) generates a pool of addresses that are tested for uniqueness and allocated to nodes upon request. This imposes additional functionality on ARs regarding generation, storage and allocation to potentially an unknown number of MNs.

Despite being compatible with the FMIP protocol, the main limitation of advance DAD is the constraint imposed on the addressing space available to nodes. IP addresses to be used by nodes are now determined by the AR. For example, this makes it difficult to exploit the security benefits of Cryptographically Generated Addresses (CGA) whereby a node uses a key in its possession to generate a link local address for itself [7]. CGA has been developed as a technique to prevent identity spoofing of a node taking part in neighbourhood discovery message exchanges. A node that has been allocated an address by the AR continues to be exposed to the threats countered by CGA. A particular threat is the re-direction attack whereby a malicious node spoofs the identity of a legitimate node and requests the last hop router to re-direct data intended for the node to another interface.

The present invention seeks to remove the constraint imposed on the addressing space available to a node during the operation of the advance DAD procedure and thereby benefit from techniques such as CGA where a node is required to have complete freedom over address generation. In one aspect, the basic concept is for the MN to use a temporary DAD cleared address allocated by the AR to maintain ongoing sessions whilst in parallel the MN performs conventional DAD on self-derived address, e.g., CGA based address. The MN relinquishes the temporary address upon completion of the conventional DAD process. This procedure is referred to as Hybrid DAD and contains all the main advantages of advance DAD including FMIP/MIP compatibility and additionally affords the security benefits of using CGA based addresses.

It should also be noted that the use of temporary addresses reduces the computational load on ARs. As temporary addresses are returned to ARs after completion of conventional DAD, the ARs have to generate and maintain a much smaller pool of DAD cleared addresses leading to lower memory and processing demands on ARs in comparison to the advance DAD procedure.

Specifically, the invention provides a method as claimed in claim 1. Preferred features of the invention are described in the subsidiary claims.

An example of the invention will now be described showing compatibility with the predictive and reactive modes of the FMIP protocol with reference to the accompanying drawings in which like parts are designated like reference numerals and in which:

FIG. 1 schematically illustrates a MN with an ongoing session with a CN (not shown) in the process of handing over between AP1 and AP2.

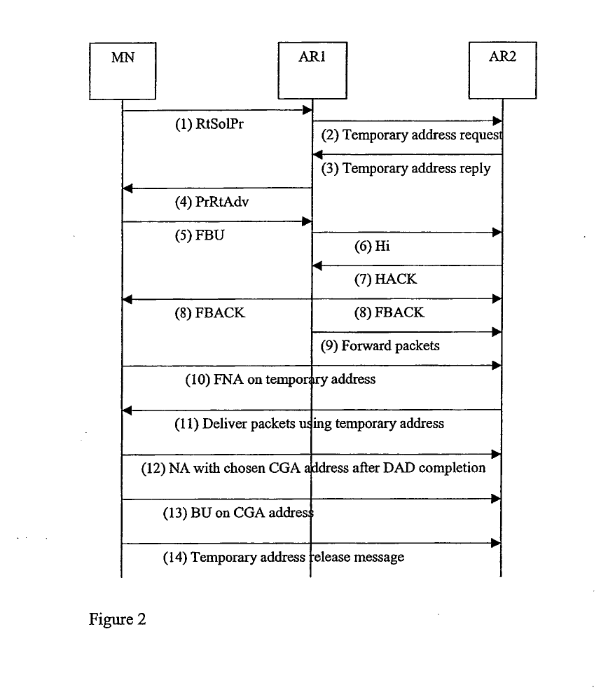

FIG. 2 illustrates steps 1 to 14 of the signal flow diagram required to complete hybrid DAD with the FMIP handover predictive mode.

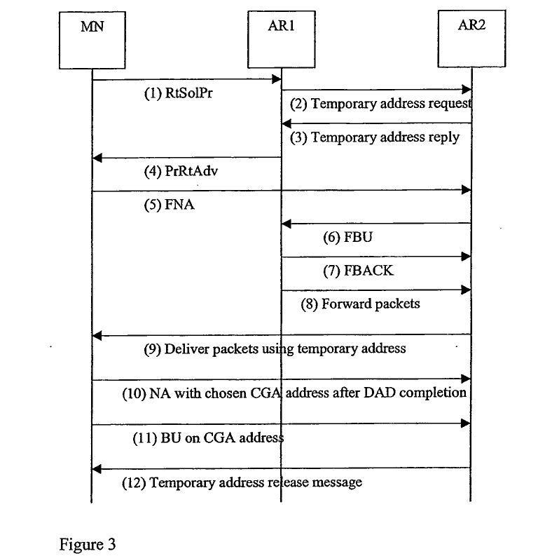

FIG. 3 illustrates steps 1 to 12 of the signal flow diagram required to complete hybrid DAD with the FMIP handover reactive mode.

The process of completing a FMIP predictive mode handover between two ARs whilst utilising hybrid DAD occurs in a number of distinct steps whose timing is shown in FIG. 2. Each step is now described in detail.

Step 1—the MN sends the Router Solicitation for Proxy (RtSolPr) to AR1 requesting information for the impending handover.
Step 2—AR1 follows advance DAD and requests a DAD cleared address to be used by MN upon connection to AR2. The present invention will only use this address temporarily.
Step 3—AR2 returns DAD cleared address to AR1.
Step 4—DAD cleared address is relayed by AR1 to MN within the Proxy Router Advertisement (PrRtAdv) message.
Step 5—the Fast Binding Update (FBU) message is sent from the MN to notify AR1 that it is about to change to AR2.
Step 6—this readiness by the MN to change ARs is relayed by AR1 to AR2 within the Handover Initiation (HI) message.
Step 7—AR2 acknowledges readiness to receive MN within the Handover Acknowledgement (HACK) message.
Step 8—AR1 sends Fast Binding Acknowledgement (FBACK) to both MN and AR2. Arrival of FBACK at AR2 is the trigger for packets to be tunnelled between AR1 and AR2 and subsequently buffered at AR2 (step 9).
Step 9 separates the predictive and reactive modes of FMIP. In the predictive mode, FBACK is received by the MN via ARI indicating that packet tunnelling will already be in progress between AR1 and AR2 when the MN arrives on the new link. In the reactive mode, the MN does not receive FBACK via AR1 perhaps because it did not send an FBU on account of leaving the old link too quickly (step 5) or that the FBU was somehow lost. Therefore in the reactive mode, the MN has to issue the FBU after arriving on the new link to start packet tunnelling between AR1 and AR2.
Step 10—the MN issues a Fast Neighbour Advertisement (FNA) to AR2 to announce that it will be using the temporary address on the new network.
Step 11—the FNA is the trigger for AR2 to commence delivery of buffered packets to MN temporary address.
Step 12—MN generates a CGA address from prefixes advertised by AR2 and commences conventional DAD that culminates in the transmission of a Neighbour Advertisement (NA) informing its neighbours of a DAD cleared CGA address that it would like to use whilst connected to AR2.
Step 13—a Binding Update (BU) is sent to AR2 that causes the tunnel between ARI and AR2 to be torn down and data delivered to MN directly via AR2. Although not shown, AR2 also relays the BU to MN Home Agent (HA) and CN to effect direct data delivery to MN.
Step 14—MN sends Temporary Address Release Message to explicitly inform AR2 that it is relinquishing the temporary address enabling its return to the DAD cleared pool maintained by AR2. This would require a new ICMPv6 temporary address release message, which would also be communicated to the new network serving base station.

FIG. 3 shows the timing of the number of distinct steps required to complete FMIP reactive mode handover. As explained above, the significant difference from the predictive case (FIG. 2) is that the MN sends the FBU through AR2 to commence the process leading up to packet tunnelling between AR1 and AR2.

### REFERENCES

[1] RFC3344, IP Mobility Support for IPv4
   http://www.ietf.org/rfc/rfc3344.txt?number=3344
[2] Draft-ietf-mobileip-ipv6-24.txt, Mobility Support in IPv6
   http://www.ietf.org/internet-drafts/draft-ietf-mobileip-ipv6-24.txt
[3] Draft-ietf-mobileip-fast-mipv6-08.txt, Fast Handovers for Mobile IPv6
   http://www.ietf.org/internet-drafts/draft-ietf-mobileip-fast-mipv6-08.txt
[4] RFC2461, Neighbour Discovery for IP Version 6 (IPv6)
   http://www.ietf.org/rfc/rfc2461.txt?number=2461
[5] Draft-moore-ipv6-optimistic-dad-03.txt, Optimistic Duplicate Address Detection
   http://bluesky.zoic.org/sharkey/draft-moore-ipv6-optimistic-dad-03.txt
[6] Draft-han-mobileip-adad-01.txt, Advance Duplicate Address Detection
   http://www.ietf.org/internet-drafts/draft-han-mobileip-adad-01.txt
[7] P. Nikander, Denial-of-Service, Address Ownership, and Early Authentication in the IPv6 World, Cambridge Security Protocols Workshop 2001, Apr. 25-27, 2001.

1. A method of managing the handover of a mobile node (MN) from a first communications node to a second communications node in which an address that has been cleared by Duplicate Address Detection (DAD) is temporarily allocated to the mobile node.

2. A method as claimed in 1 in which the temporary address is relinquished once a different address generated by the mobile node has been cleared by DAD.

3. A method as claimed in claim 2 wherein the cessation of the usage of the temporary address by the MN is communicated to the second communications node via a temporary address release message.

4. A method as claimed in claim 2 in which the cessation of the usage of the temporary address is communicated by the second communications node to the mobile node after communication using a new DAD cleared address has been established.

5. A method as claimed in claim 1 in which the temporary address is one of a list of DAD cleared temporary addresses stored at the second communications node.

6. A method as claimed in claim 1 in which the first and second communications nodes belong to first and second networks respectively.

7. A method as claimed in claim 1 in which the first and second communications nodes are Access Routers (AR).

8. A method as claimed in claim 7 wherein for the case of a Fast Mobile IP (FMIP) handover, the temporary address along with an indication that the address is temporary is carried on the Fast Binding Update (FBU) message between the MN and the first access router (AR).

9. A method as claimed in claim 7 wherein for the case of a Fast Mobile IP (FMIP) handover, the temporary address along with an indication that the address is temporary is carried on the Handover Initiation (HI) between first and second ARs.

10. A method as claimed in claim 7 wherein for the case of a Fast Mobile IP (FMIP) handover, the Fast Neighbour Advertisement (FNA) issued by the MN carries the temporary address along with an indication that the address is temporary to claim data from the second AR.
